(19) United States
(12) Patent Application Publication
(10) Pub. No.: US 2012/0256012 A1
(43) Pub. Date: Oct. 11, 2012

(54) FOUNTAIN FOR EDIBLE FLUIDS

(76) Inventor: Justin Posner, Bushey (GB)

(21) Appl. No.: 13/415,610

(22) Filed: Mar. 8, 2012

(30) Foreign Application Priority Data
Mar. 11, 2011 (GB) GB1104147.2
Apr. 28, 2011 (GB) GB1107213.9

(51) Int. Cl. B05B 17/08

(52) U.S. Cl. 239/17

(57) ABSTRACT

A fountain for edible fluids includes a bowl and an open tubular column extending substantially normally of the bowl from a fluid intake position near the bottom of the bowl to a fluid outlet position remote therefrom. The tubular column contains an auger or other drive to drive edible fluids up through the tubular column. The tubular column has on its exterior a plurality of lugs spaced apart at intervals along the length thereof and the fountain further comprises a plurality of mounting members that mount onto the tubular column, each mounting member mounting onto a lug at a different respective position along the tubular column. Each mounting member serves to supportively mount a respective tier of the fountain thereon. This system is easy to assemble and disassemble, there are no loose fixings and the column may be made of uniform diameter and the tiers of simple form.

### FIELD OF THE INVENTION

The present invention concerns fountains for edible fluids as exemplified by the chocolate fountain.

### BACKGROUND TO THE INVENTION

Liquid chocolate fountains for chocolate fondue though ubiquitous nowadays were, according to general understanding, first invented in the 1920s by a Ben Brisman and were initially developed primarily for the high end commercial market of restaurants and caterers for weddings and other substantial events but were only re-targetted for the domestic market in the last couple of decades.

The ubiquitous form of the chocolate fountain is the stepped cone of tiers supported at intervals up a tubular central column that is capped at its apex by a crown so that chocolate heated in a bowl at the base of the fountain may be driven up through the central column by an auger and emerge to cascade over the crown and down each of the progressively broader diameter tiers back into the bowl. This configuration is present in the fountains produced by Buffet International Inc from the 1990s onwards. The majority of modern domestic chocolate fountains—including those produced by the other market leaders, such as Sephra LLC, e.g. U.S. Pat. No. 7,118,745 for use of a plastic auger—are primarily moulded of plastics but some, most notably the catering grade fountains, are partly or wholly of stainless steel.

The tiers of the fountain are commonly secured to the column at their selected heights by set screws or by providing a conical taper of the central column on which the tiers sit at corresponding heights matching their respective differing central aperture diameters. In a further variant of the latter, the central column has differing diameter annular ledges on the column at intervals down the column again to match the respective differing central aperture diameters of the tiers and each tier is notched to locate firmly onto the respective ledge. The latter arrangements hold the tiers at their respective heights yet avoid need to use fixings to ease disassembly and re-assembly of the fountain for proper cleaning and maintenance.

The present inventor has previously come up with improvements to chocolate fountains such as that set forth in GB 2 456 825, wherein the fountain has multiple flow circuits for the chocolate fondue to allow for parallel flows of, for example, light and dark chocolates and which holds the tiers each by a respective arm on an external support structure. Now it is an objective of the present invention to provide a new configuration of chocolate fountain that avoids need for an external support structure or need for set screws or other fixings to mount the tiers to the central column and which does not require the tiers themselves to be of complex form or the column itself to be tapered.

### SUMMARY OF THE INVENTION

According to a first aspect of the present invention there is provided a fountain for edible fluids that comprises: a basal bowl (heated in use) and an open tubular column extending substantially normally of the bowl from a fluid intake position near the bottom of the bowl to a fluid outlet position remote therefrom, the tubular column containing an auger or other drive means to drive edible fluids up through the tubular column, wherein the tubular column has on its exterior a plurality of lugs spaced apart at intervals along the length thereof and the fountain further comprises a plurality of mounting members that fit onto the tubular column, each mounting member sitting onto a lug at a different respective position along the tubular column, each mounting member serving to supportively mount a respective tier of the fountain thereon.

The lugs are not annular shoulders or ledges, they do not extend fully around the circumference of the tubular column but are each arranged to project from a discrete radial portion of the tubular column. The lugs are particularly preferably integral to the column, being integrally formed or assembled to it and with each lug preferably projecting to the same extent from the column. In the inter-fit of the lugs and mounting members there are no loose fixings involved and the process of mounting the tiers on the column or de-mounting them is very simple.

The mounting member is preferably a mounting arm or a mounting ring. each of the plurality of tiers comprise one or more upwards facing tier bowls each supported by a said support arm.

Preferably the fountain has tiers that each comprises one or more upwards facing tier bowls. Preferably each tier bowl is supported by a support arm substantially centrally at the underside thereof. Each support arm may be cranked/configured with a U bend to extend under the bowl and then upwardly to engage in a socket or recess substantially centrally in the underside bottom of the bowl. The tier bowls may spiral down around the central column, supported to the column each by a respective radially projecting supporting arm. Preferably each successively lower tier projects farther radially outwardly from the central column by the increasingly greater length of the respective supporting arms. Each tier bowl preferably has a spout to direct the down-pouring liquid food towards the next adjacent lower tier bowl.

Where the mounting member is a ring, all of the rings, or all except the uppermost, in use, ring may have a radial gap, or a radial groove therein on the rim of the central aperture of the ring, at a defined radial position and which is configured to allow the ring to freely pass over a said lug to travel farther down the column when the radial orientation of the lug coincides with the radial orientation of the radial groove. This enables each ring to be lowered down the column to a lug at the position where the tier is to be held and secured in place by turning the tier until the radial gap or groove is not aligned with the lug at that position. The ring will thus sit on that lug and not pass down over it.

Particularly preferably each ring has not only the radial gap or groove but also at a different radial position on the rim of the central aperture of the ring an element adapted to co-operatively engage with the lug on the column. In a preferred embodiment the element is a male member and the lug has a female member (socket or recess) to receive the element to hold the ring against rotation relative to the column or vice-versa. All of the mounting rings may be substantially identical to each other. The tiers may each be a simple bowl, each of different external diameter but all of the same central aperture diameter, and without any notches on the bowls. By this arrangement the tiers can be kept simple and need not be notched or in-stepped and do not need to have a central aperture of diameter each differing from each other tier and can be mounted to a uniform diameter, un-tapered central column (which may thus be a uniform circular cylindrical cylinder).

### BRIEF DESCRIPTION OF THE DRAWINGS

Preferred embodiments of the present invention will now be further described, by way of example only, with reference to the accompanying drawings, in which:

FIG. 1 is a longitudinal sectional view of the central column, mounting rings and tiers of the chocolate fountain of the preferred embodiment as assembled (bowl and auger not shown);

FIG. 2 is a corresponding sectional view of the circular cylindrical column of the chocolate fountain, showing the uniform external diameter and the mounting lugs of the column that are spaced at intervals up the height of the column;

FIGS. 3A-C are respectively a plan view of a mounting lug of the chocolate fountain and front elevation view and side elevation view thereof;

FIGS. 4 and 4B are respectively a side elevation view of a mounting ring of the chocolate fountain and a plan view thereof;

FIGS. 5A-C are sectional views of the tiers of the chocolate fountain, each having the form of a downturned bowl, dish or saucer and having differing external diameters but all having the same central aperture diameter;

FIG. 6 is a longitudinal sectional view similar to FIG. 1, with the mounting rings assembled on the central column, but before mounting the tiers on the column;

FIG. 7 is a front elevation view of a second embodiment of the fountain having tier-supporting arms with each tier comprising a pair of small bowls supported by a respective arm, this figure showing the central column, with the mounting arms and tiers of the chocolate fountain as assembled (bowl and auger not shown);

FIG. 8 is a front elevation view of the circular cylindrical column of the second embodiment of the chocolate fountain, showing the uniform external diameter and the mounting lugs of the column that are spaced at intervals up the height of the column;

FIG. 9 is a front elevation view of a variant of the second embodiment of the chocolate fountain, having a single bowl tier at each height level up the column (unlike the double bowl tiers of the FIG. 8 fountain);

FIGS. 10A-D are side elevation views of the arms of the second embodiment, showing that these are of progressively longer reach from the central column so that the bowl (or pair or more of bowls) of each successive lower tier is held progressively farther radially outwardly from the central column; and

FIGS. 11A-D are side elevation views of the successive tiers of the chocolate fountain, each having the form of an up-facing bowl, dish or saucer with a spout and the successive tiers here having substantially identical external diameters the bowls being shown on their respective increasing reach support arms.

### DESCRIPTION OF THE PREFERRED EMBODIMENT

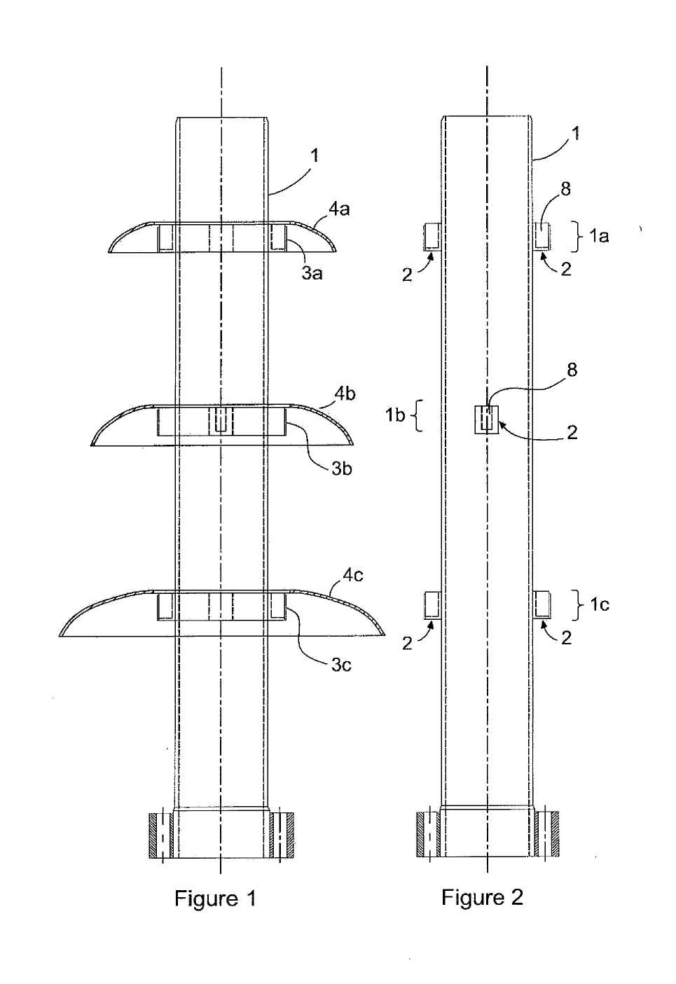

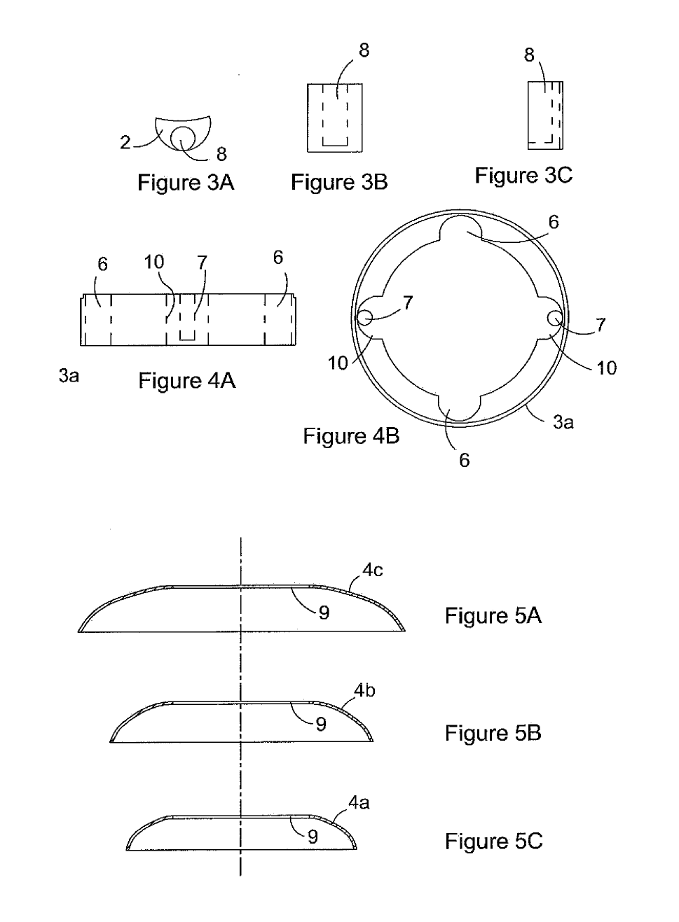

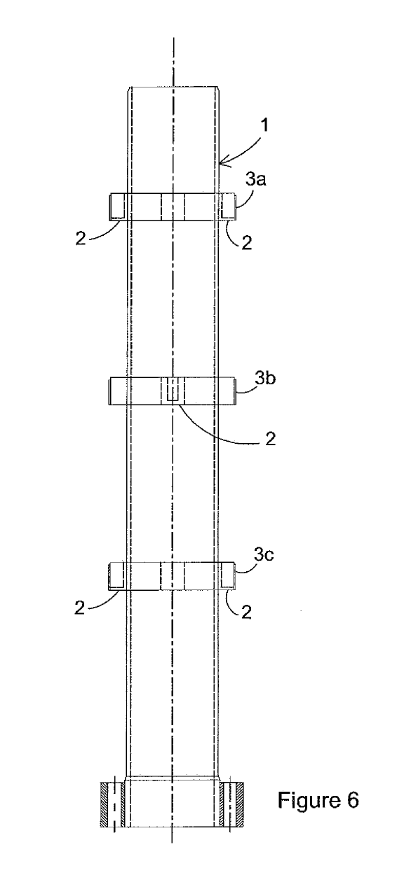

Referring to FIG. 1, the chocolate fountain assembly shown has a circular cylindrical tubular column 1 which suitably is formed of stainless steel but may alternatively, for example, be moulded of food grade plastics or other suitable materials. The column 1 has a uniform internal diameter to receive and co-operate with an auger (not shown) to drive the chocolate fondue up the column 1. The column 1 also has a uniform external diameter for substantially all of its length. The external diameter may, for example, be of the order of 62.5 cm for a column of the order of 70 cm tall. Only the base end of the column 1 has a slightly enlarged diameter close to where the column 1 is mounted upright in the centre and bottom of the heated chocolate collecting bowl (not shown) at the base of the fountain.

The central column 1 has on its cylindrical exterior surface a plurality of lugs 2 projecting radially from it at spaced apart intervals along its length. These may alternatively be referred to as bushings or load-bearing projections.

Each lug 2 is arranged to project from a discrete radial portion of the tubular column 1 and there are, in this embodiment (see FIG. 2), a pair of oppositely radially directed lugs 2 at each tier-mounting stage 1a, 1b, 1c along the length of the column 1.

A plurality of mounting rings 3a, 3b, 3c having the form of collars or sleeves are provided to fit over the tubular column 1 and each mounting ring 3a, 3b, 3c sits onto a pair of lugs 2 at a different respective tier-mounting stage 1a, 1b, 1c along the tubular column 1, each mounting ring 3a, 3b, 3c serving to supportively mount a respective tier 4a, 4b, 4c of the fountain thereon.

Each of the rings 3a, 3b, 3c have a pair of opposing radial grooves 6 therein, on the rim of the central aperture 5 of the ring, and which extend parallel to the longitudinal direction of the column 1 in use. These grooves 6 are configured so that when aligned with the lugs 2 they allow the ring to freely pass over each opposing pair of lugs 2 at each tier-mounting stage 1a, 1b, 1c to travel farther down the column 1 until the tier reaches its intended tier-mounting stage 1a, 1b or lc. Each ring 3a, 3b, 3c can thus be lowered down the column 1 to the tier-mounting stage where the tier 4a, 4b, 4c is to be held and can then be secured in place simply by turning the tier 4a, 4b, 4c until the radial groove 6 does not radially coincide/align with the pair of lugs 2 at that tier-mounting stage. The ring will thus sit on the pair of lugs 2 at that tier-mounting stage and not pass down over it.

Each ring 3a, 3b, 3c further has, at a different radial position on the rim of the central aperture 5 of the ring from the radial grooves 6, at least one locking element 7 adapted to co-operatively engage with the lug 2 on the column to prevent further rotation of that ring until the ring is lifted on the column 1. In the illustrated embodiment there is a pair of such elements 7 arranged in secondary radial grooves 10 at radially opposing locations on the ring 3a, 3b, 3c intermediate the opposing radial grooves 6. Each locking element 7 comprises a male member (pin). The lug 2 to which the ring mounts has a corresponding female member 8 socket or recess to receive the element 7 to hold the ring against rotation relative to the column 1. In an alternative embodiment having a converse arrangement, each element 7 on the ring 3 might comprise a female member and the lug 2 might have corresponding male members.

The tiers 4a, 4b, 4c may each be a simple downturned (inverted) bowl-like structure, each of different external diameter but all having a central aperture 9 to ride up and down the column 1 where the diameter of the central aperture 9 is the same for each tier. In the illustrated example in FIG. 1 the tiers 4a, 4b, 4c are of larger and larger external diameter down the column 1 to create the cascade effect but all have a central aperture diameter of 82.2 mm. Furthermore the simple downturned (inverted) bowl-like structure of each tier has no notch or rebate on the bowl's central aperture 9 rim.

By the arrangement of the present invention the tiers can be kept simple and need not be notched or in-stepped and do not need to have a central aperture of diameter each differing from each other tier and they can be mounted to a uniform diameter, un-tapered central column. The lugs 2 are integral to the column, being integrally formed (e.g. cast with the column 2) or more preferably, and as illustrated, integrally assembled to it (e.g. by welding) and each lug 2 projects to the same extent from the column 1. Where the column is of simple uniform shape it may be formed quickly and cheaply by extrusion. There are no loose fixings involved and the process of mounting the tiers on the column or de-mounting them involves no more than a simple partial turning action when raising or lowering the tiers 4a, 4b, 4c on the column 1.

Though not illustrated here the rest of the fountain may be broadly conventional or of any suitable form. The top of the cylinder 1 suitably supports, in conventional manner, an inverted bowl in the form of a crown for the fountain.

The crown collects liquid chocolate from the cylinder 1 and causes it to overflow from its top rim, forming a cascade down to the top surface of the uppermost tier. From there, the fluid drops to each successive tier and then into the collecting bowl at the base of the fountain in which it is re-heated to re-circulate up through the cylinder 1 again.

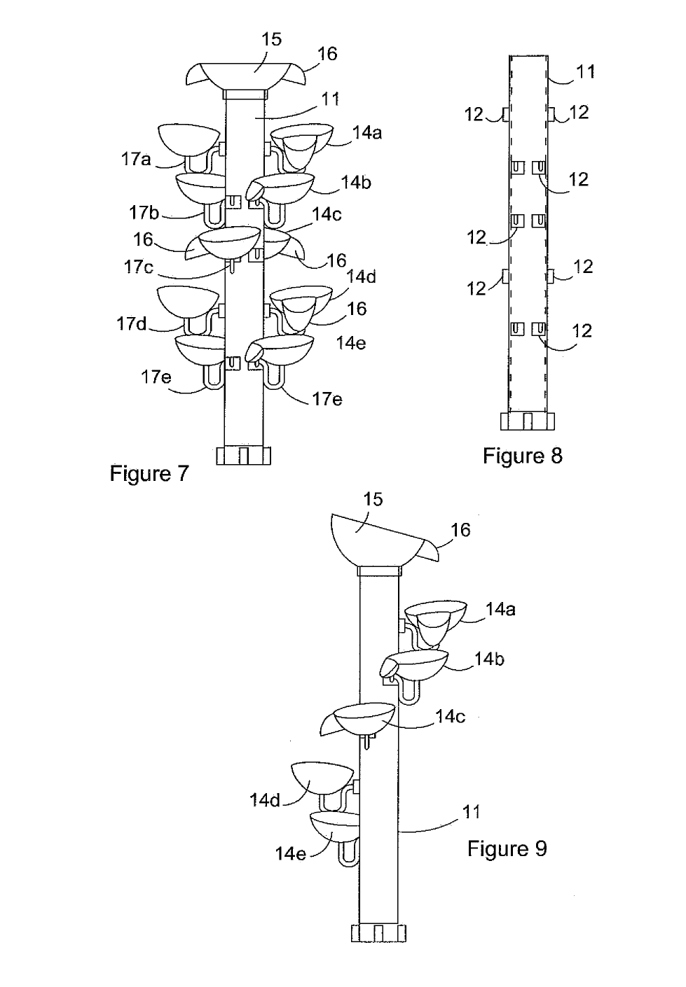

Referring now to FIGS. 7 to 11, these show the second embodiment of the chocolate fountain. Here the five illustrated tiers 14a-14e each comprise a pair of upwards facing small tier bowls. All of the tier bowls are of substantially the same external diameter and not annular—they do not have a central aperture to mount over the central column 11. The tier bowls of each tier 14a-14e are arranged in radially opposing pairs and the bowls spiral down around the central column 11, supported to the column 11 each by a respective radially projecting supporting arm 17a-e.

Each successive tier projects farther radially outwardly from the central column 11 by the increasingly greater length of the respective supporting arms 17a-e (see FIGS. 11A-D). The illustrated arms 17a-e are cranked/configured with a U bend to extend under the bowl and then upwardly to engage in a socket or recess substantially centrally in the underside bottom of the bowl, suitably either as a push fit or screw fit for ease of demounting the tier bowls when needed. Alternatively each tier bowl may be integrally assembled to an arm and demounted from the column 11 by demounting the arm from the respective mounting lug 12 on the column. The central column 11 is very similar to the central column 1 of the first embodiment, being of substantially uniform width down its length and having mounting lugs 12 at intervals down its length, each arranged to project from a discrete radial portion of the tubular column 11. The mounting lugs 12 are sockets into each of which a respective one of the supporting arms 17a-e is mounted. In a converse arrangement the mounting lugs may define pin/male formations to engage with a socket/female formation on the supporting arms.

As best seen in FIG. 8, the larger diameter top bowl 15 serves as the crown and is mounted upwardly-facing at the top of the central column 11. It has a pair of radially oppositely directed spouts 16 to direct the liquid chocolate down to the pair of radially opposing small bowls of the uppermost tier 14a just below it. The tier bowls of the tiers 14a-14e each also have a pair of spouts 16 to direct the down-pouring liquid chocolate towards the next adjacent lower tier but each spout is directed laterally rather than radially outwardly since the recipient bowl of each next adjacent lower tier is radially offset relative to the bowl above that feeds into it.

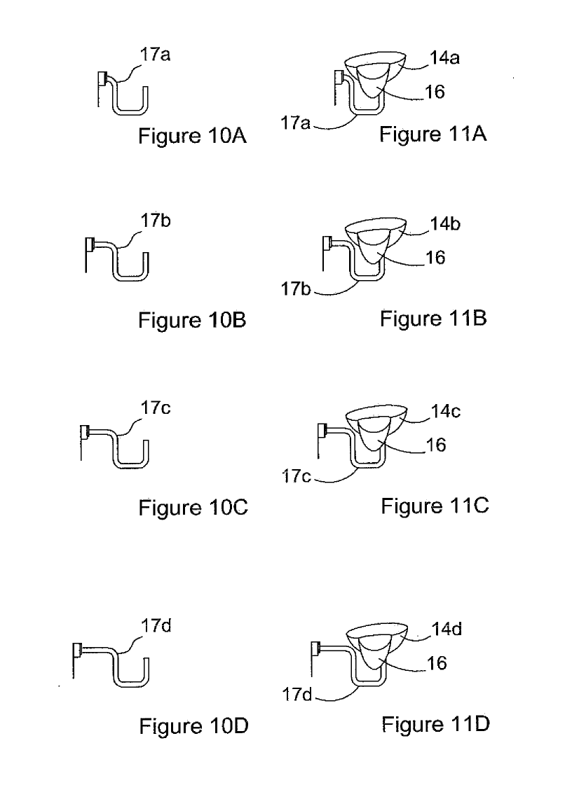

FIG. 10 shows a variant of the second embodiment of the chocolate fountain, having a single bowl in each tier at each height level up the column.

1. A fountain for edible fluids that comprises: a bowl and an open tubular column extending substantially normally of the bowl from a fluid intake position near the bottom of the bowl to a fluid outlet position remote therefrom, the tubular column containing an auger or other drive means to drive edible fluids up through the tubular column, characterised in that the tubular column has on its exterior a plurality of lugs spaced apart at intervals along the length thereof and the fountain further comprises a plurality of mounting members that fit onto the tubular column, each mounting member mounting onto a lug at a different respective position along the tubular column, each mounting member serving to supportively mount a respective tier of the fountain thereon.

2. A fountain as claimed in claim 1, wherein the lugs are integral to the column, being integrally formed or assembled to it.

3. A fountain as claimed in claim 1, wherein each lug projects to substantially the same extent from the column.

4. A fountain as claimed in claim 1, wherein the central column has a uniform external diameter for substantially its full length.

5. A fountain as claimed in claim 4, wherein the central column is a circular cylindrical cylinder.

6. A fountain as claimed in claim 1, wherein there are two or more differently radially directed lugs at each tier-mounting stage along the length of the column.

7. A fountain as claimed in claim 6, wherein there are a pair of radially oppositely directed lugs at each tier-mounting stage along the length of the column.

8. A fountain as claimed in claim 1, wherein the mounting member comprises a mounting arm.

9. A fountain as claimed in claim 8, wherein each of the plurality of tiers comprise one or more upwards facing tier bowls each supported by a said support arm.

10. A fountain as claimed in claim 9, wherein each of the upwards facing tier bowls is supported by a said support arm substantially centrally at the underside thereof.

11. A fountain as claimed in claim 10, wherein each arm is cranked/configured with a U bend to extend under the bowl and then upwardly to engage in a socket or recess substantially centrally in the underside bottom of the bowl.

12. A fountain as claimed in claim 8, wherein the tier bowls spiral down around the central column, supported to the column each by a respective radially projecting supporting arm.

13. A fountain as claimed in claim 8, wherein each successively lower tier projects farther radially outwardly from the central column by the increasingly greater length of the respective supporting arms

14. A fountain as claimed in claim 8, wherein each each tier bowl has a spout to direct the down-pouring liquid food towards the next adjacent lower tier bowl.

15. A fountain as claimed in claim 1, wherein the mounting members comprise mounting rings.

16. A fountain as claimed in claim 15, wherein at least one of the mounting rings has a radial gap, or a radial groove therein on the rim of the central aperture of the ring, at a defined radial position and which is configured to allow the ring to freely pass over a said lug to travel farther down the column when the radial orientation of the lug coincides with the radial orientation of the radial gap or groove.

17. A fountain as claimed in claim 15, wherein the ring further has, at a different radial position of the ring from the gap or groove, an element adapted to co-operatively engage with the lug on the column.

18. A fountain as claimed in claim 17, wherein the element is a male member and the lug has a female member (socket or recess) to receive the element to hold the ring against rotation relative to the column, or vice-versa.

19. A fountain as claimed in claim 15, wherein all of the mounting rings are substantially identical to each other.

20. A fountain as claimed in claim 15, wherein all tiers have the same central aperture diameter.

21. A fountain as claimed in claim 15, wherein the process of mounting the tiers on the column or de-mounting them involves no more than a simple partial turning action when raising or lowering the tiers on the column.
